(19) United States
(12) Patent Application Publication
(10) Pub. No.: US 2005/0104694 A1
(43) Pub. Date: May 19, 2005

(54) Low-voltage and low-power toggle type-SPDT RF MEMS switch actuated by combination of electromagnetic and electrostatic forces

(75) Inventors: Il-Joo Cho, Daejeon (KR); EuiSik Yoon, Daejeon (KR)

Correspondence Address: OLIFF & BERRIDGE, PLC, P.O. BOX 19928, ALEXANDRIA, VA, 22320, US

(73) Assignee: KOREA ADVANCED INSTITUTE OF SCIENCE AND TECHNOLOGY, Yuseong-gu (KR)

(21) Appl. No.: 10/980,333

(22) Filed: Nov. 4, 2004

(30) Foreign Application Priority Data
Nov. 13, 2003 (KR) 2003-80198

(51) Int. Cl. G02B 6/26

(52) U.S. Cl. 335/78

(57) ABSTRACT

Disclosed is a toggle type SPDT MEMS switch wherein an input port of the switch is always connected to one of two output ports of the switch while driving the switch by an electromagnetic force generated by a magnetic field and maintaining a switching state by an electrostatic force. Since the MEMS switch performs switching using the electromagnetic force which is stronger than the electrostatic force, it can perform reliable operation, have a mechanically robust structure, and handle high power signals. In addition, since initial displacement can become large, large isolation can be obtained when the switch is turned off. In addition, since the MEMS switch maintains an ON state using the electrostatic force in a state where a distance between two electrodes is small without using the electrostatic force after switching, it can be operated with a relatively low voltage. In addition, since current is applied only at the moment of switching in order to generate the electromagnetic force, power consumption is low. Further, since the MEMS switch is implemented by only one toggle type switch and is integrated on one substrate by a MEMS fabrication technique, the entire size of the switch is very small.

### BACKGROUND OF THE INVENTION

1. Field of the Invention

The present invention relates to a radio frequency (RF) micro electro mechanical system (MEMS) switch, and more particularly to a toggle type-single pole double throw (SPDT) switch having one input port and two output ports, with the input port always connected to one of the two output ports.

2. Description of the Related Art

Many systems used in the RF band are gradually becoming sub-miniaturized, ultra-light, and improved in regard to their performance. In order to control electrical signals in these systems, semiconductor switches, such as field effect transistors (FET) or pin diodes, have been conventionally used. However, such semiconductor switches have many problems including large loss of power when exposed to the atmosphere state, incomplete on/off operation, etc.

In order to overcome these problems, recently, a mechanical RF MEMS switch using micromachining technology has been widely studied. This MEMS switch can overcome drawbacks of the existing semiconductor switches, which may be caused due to low insertion loss, high isolation, and linearity of operation characteristics.

Operation of the MEMS switch may be classified into electrostatic force operation and electromagnetic force operation depending on its operation method.

The electrostatic force operation is an operation where the MEMS switch is turned on/off by an electrostatic force effecting between two plates. The MEMS switch of this electrostatic force operation type has an advantage in that a structure of the switch and a fabrication process thereof are simple, however, it has a disadvantage in that it is difficult to obtain reliable operation since an operation voltage is high and a generated electrostatic force is low. As one example, U.S. Pat. No. 6,440,767 issued to Robert Y. Loo etc. discloses a structure of a MEMS switch and a fabrication method thereof using the electrostatic force.

On the other hand, as to the electromagnetic force operation, there is a method proposed by Microlab in U.S.A., where an external magnet is used to generate a magnetic field and a MEMS switch is turned on/off in such a manner that a cantilever consisting of magnetic material is pulled, depending on whether an opposite magnetic field generated by flowing current through a coil is present or not. However, this method has a disadvantage in that power consumption is high as compared to the electrostatic force operation method since a strong magnetic field must be generated by flowing high current through the coil, and the size of the MEMS switch is large due to the coil.

### SUMMARY OF THE INVENTION

Therefore, it is an object of the present invention to provide a toggle type SPDT MEMS switch having both merits of the electrostatic force operation method and the electromagnetic force operation method by operating the MEMS switch using an electromagnetic force and, after this, maintaining an operation state of the MEMS switch using an electrostatic force.

In accordance with an aspect of the present invention, the above and other objects can be accomplished by the provision of a toggle type SPDT MEMS switch wherein an input port of the switch is always connected to one of two output ports of the switch while driving the switch by an electromagnetic force generated by a magnetic field generated by a magnetic field generating means and maintaining a switching state of the switch by an electrostatic force.

As one embodiment, the toggle type SPDT MEMS switch comprises: a magnetic field generating means for generating a magnetic field within a given space; a seesawing cantilever located in the space; a driving conductive wire provided in the cantilever for generating an electromagnetic force to drive the cantilever by interaction between the driving conductive wire and the magnetic field when current flows through the driving conductive wire; an electrostatic force metal plate arranged in a position opposite to the driving conductive wire for generating an electrostatic force between the electrostatic force metal plate and the driving conductive wire when a voltage is applied to the electrostatic force metal plate; a contact metal plate provided in both ends of the cantilever; and input/output conductive wires for passing a signal of one input conductive wire to one of two output conductive wires by making electrical contact with the contact metal plate according to seesawing movement of the cantilever.

As an alternative embodiment, the toggle type SPDT MEMS switch comprises: a magnetic field generating means for generating a magnetic field within a given space; a cantilever located in the space; a driving conductive wire provided in the cantilever for generating an electromagnetic force to drive the cantilever by interaction between the driving conductive wire and the magnetic field when current flows through the driving conductive wire; a torsion bar for supporting a middle portion of the cantilever such that the cantilever seesaws; a post for supporting the torsion bar; a current application conductive wire for connecting the post with the driving conductive wire; electrostatic force metal plates arranged at both lower portions of the driving conductive wire in a position opposite to the driving conductive wire for generating an electrostatic force between the electrostatic force metal plates and the driving conductive wire when a voltage is applied to the electrostatic force metal plates; a contact metal plate provided in the bases of both ends of the cantilever; and input/output conductive wires for passing a signal of one input conductive wire to one of two output conductive wires by making electrical contact with the contact metal plate according to seesawing movement of the cantilever.

In the embodiments, preferably, the cantilever is formed of an isolator such as silicon oxide or silicon nitride.

In the embodiments, preferably, all elements except the magnetic field generating means are integrated on a substrate. In this case, a silicon substrate or a glass substrate is used as the substrate

### BRIEF DESCRIPTION OF THE DRAWINGS

The above and other objects, features and other advantages of the present invention will be more clearly understood from the following detailed description taken in conjunction with the accompanying drawings, in which:

FIGS. 1 to 4 are diagrams illustrating a toggle type SPDT MEMS switch according to the present invention.

### DESCRIPTION OF THE PREFERRED EMBODIMENTS

Hereinafter, preferred embodiments of the present invention will be described in detail with reference to the accompanying drawings.

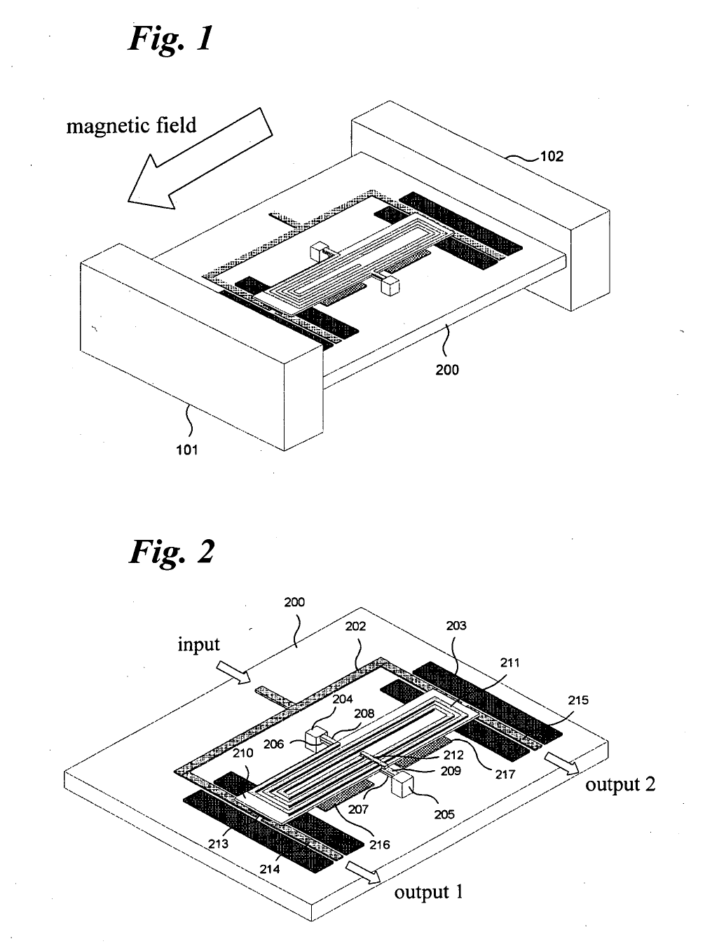

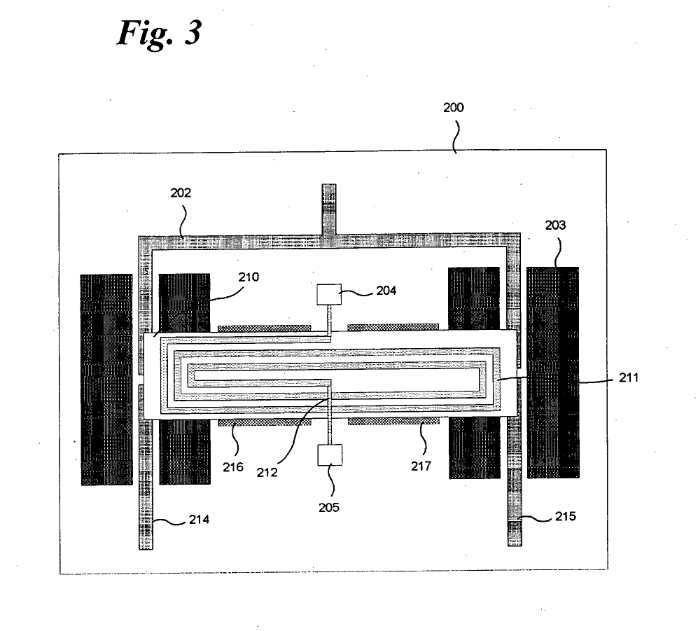

FIGS. 1 to 4 are diagrams illustrating a toggle type SPDT MEMS switch according to the present invention. FIG. 1 is a perspective view illustrating a basic concept of a toggle type SPDT MEMS switch according to the present invention. FIG. 2 is a perspective view illustrating a toggle type SPDT MEMS switch according to an embodiment of the present invention. FIG. 3 is a plan view of FIG. 2. In FIG. 2, permanent magnets 101 and 102 for generating a magnetic field are not shown in order to avoid over-complicating the figure.

Referring to FIGS. 1 to 3, the SPDT MEMS switch operates in a magnetic field generating space. Permanent magnets 101 and 102 having different polarities are provided as a magnetic field generating means at both sides of the SPDT MEMS switch. Arrows indicate the direction of the magnetic field.

A cantilever 210 used as a structure for supporting the SPDT MEMS switch is placed in the magnetic field generating space and is made of an isolator such as silicon oxide or silicon nitride. Torsion bars 206 and 207 allowing the cantilever 210 to seesaw by an electromagnetic force are provided at a middle portion of the cantilever 210.

A driving conductive wire 211 is compactly arranged on an upper side of the cantilever 210. When current flows through the driving conductive wire 211, an electromagnetic force for seesawing the cantilever 210 is generated by interaction between the current and the magnetic field generated by the permanent magnets 101 and 102.

The torsion bars 206 and 207 are supported by posts 204 and 205. The posts 204 and 205 are electrically connected to the driving conductive wire 211 by current application conductive wires 208 and 209. Driving current is externally applied to the current application conductive wires 208 and 209 via the posts 204 and 205.

When the driving conductive wire 211 assumes a multiple-wound shape, a bridge conductive wire 212 for connecting an inside end of the driving conductive wire 211 to the current application conductive wires 208 and 209 is required. The bridge conductive wire 212 is floated with a certain interval over the cantilever.

Electrostatic force metal plates 216 and 217 are provided on a substrate 200 under both sides of the cantilever 210. When a voltage is applied to the electrostatic force metal plates 216 and 217, an electrostatic force is generated between the electrostatic force metal plates 216 and 217 and the opposite driving conductive wire 211.

Contact metal plates 213 are respectively provided at the bottom of both ends of the cantilever. One input conductive wire 202 to which high frequency signals and the like are inputted and two output conductive wires 214 and 215 are provided on the substrate 200 in such a manner that the input conductive wire 202 can be disconnected from the output conductive wires 214 and 215 at positions under the contact metal plates 213. When the cantilever 210 seesaws, the input conductive wire 202 is connected to one of the two output conductive wires 214 and 215 by the contact metal plate 213.

Since all elements except the permanent magnets 101 and 102 are integrated on the substrate 200 by a MEMS fabrication technique, the size of the SPDT MEMS switch is very small. The substrate 200 should be an isolator such as silicon or glass. Reference numeral 203 denotes a ground conductive wire 203 for reducing signal loss.

Now, a method of driving the SPDT MEMS switch of the present invention will be described.

In an initialization state where current does not flow through the driving conductive wire 211, the input conductive wire 202 and the output conductive wires 214 and 215 are all in an off state, i.e., a state where they are electrically disconnected. When current is externally applied to the driving conductive wire 211 through the posts 204 and the current application conductive wires 208 and 209 and a magnetic field is generated in a direction as indicated by an arrow in FIG. 1, a portion of the driving conductive wire 211 perpendicular to the direction of the magnetic field encounters an electromagnetic force.

When one end of the cantilever 210 moves downward as the cantilever 210 is swung around a rotational axis, i.e., the torsion bars 206 and 207, by the electromagnetic force, the input conductive wire 202 is connected to one of a first output conductive wire 214 and a second output conductive wire 215 by the contact metal plate 213. When current flows through the driving conductive wire 211 in an opposite direction, the rotation direction of the cantilever 210 is reversed and hence the other end of the cantilever 210 moves downward.

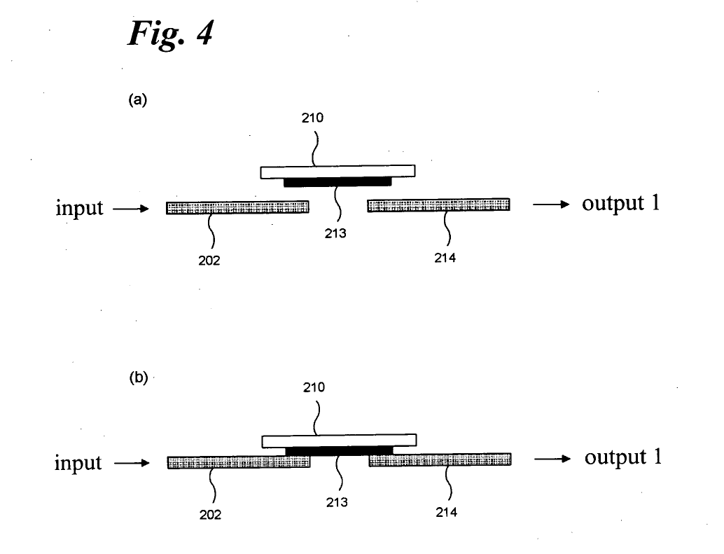

FIG. 4 shows a case where the cantilever 210 is rotated in the counterclockwise direction so that the input conductive wire 202 is connected to the first output conductive wire 214 and hence a first switch is turned on. After the input conductive wire 202 is connected to the first output conductive wire 214 by the rotation of the cantilever 210, a voltage is applied to the electrostatic metal plate 216 positioned in the vicinity of the first output conductive wire 214 and the driving conductive wire 211 is grounded. Then, even when current does not flow through the driving conductive wire 211, the cantilever 210 is pulled downward by the electrostatic force generated between the electrostatic force metal plate 216 and the driving conductive wire 211, thereby keeping the first switch in an ON state.

When the distance between the electrostatic force metal plate 216 and the driving conductive wire 211 becomes small as the cantilever 210 is rotated by the electromagnetic force generated by the interaction between the current flowing through the driving conductive wire 211 and the magnetic field generated by the permanent magnets 101 and 102, the electrostatic force acting between the electrostatic force metal plate 216 and the driving conductive wire 211 becomes strong, and accordingly, the first switch maintains the ON state even when current does not flow through the driving conductive wire 211. Accordingly, an operation voltage required to keep the first switch in the ON state is small and no power is consumed.

In order to connect the input conductive wire 202 to a second output conductive wire 215 to thereby turn a second switch on, voltage applied to the electrostatic force metal plate 216 is removed and the direction of the current flowing through the driving conductive wire 211 is reversed. Then, the cantilever 210 is rotated in the clockwise direction, and accordingly, the input conductive wire 202 is connected to the second output conductive wire 215.

Since the electromagnetic force is involved in changing the rotation of the cantilever 210 from the counterclockwise direction to the clockwise direction, a rotary power is strong, and accordingly, signals having high power can be handled.

As apparent from the above description, according to the present invention provides an SPDT MEMS switch using an electromagnetic force at the moment of switching and using an electrostatic force after switching. Since the SPDT MEMS switch performs switching operation by using the electromagnetic force which is stronger than the electrostatic force, it can perform reliable operation, have a mechanically robust structure, and handle high power signals. In addition, since initial displacement can become large, large isolation can be obtained when the switch is turned off.

In the case that the switch is operated by only the electromagnetic force, there is a problem in that power consumption is high since current continues to be supplied although generated force is large. However, since the SPDT MEMS switch according to the present invention maintains an ON state using the electrostatic force in a state where a distance between two electrodes is small without using the electrostatic force after switching, it can be operated with a relatively low voltage. In addition, since current is applied only at the moment of switching in order to generate the electromagnetic force, power consumption is low.

Further, since the SPDT MEMS switch according to the present invention is implemented by only one toggle type switch and is integrated on one substrate by a MEMS fabrication technique, the entire size of the switch is very small.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A toggle type SPDT MEMS switch wherein an input port of the switch is always connected to one of two output ports of the switch while driving the switch by an electromagnetic force generated by a magnetic field generated by a magnetic field generating means and maintaining a switching state of the switch by an electrostatic force.

2. A toggle type SPDT MEMS switch comprising:
a magnetic field generating means for generating a magnetic field within a given space;
a seesawing cantilever located in the space;
a driving conductive wire provided in the cantilever for generating an electromagnetic force to drive the cantilever by interaction between the driving conductive wire and the magnetic field when current flows through the driving conductive wire;
an electrostatic force metal plate arranged in a position opposite to the driving conductive wire for generating an electrostatic force between the electrostatic force metal plate and the driving conductive wire when a voltage is applied to the electrostatic force metal plate;
a contact metal plate provided in both ends of the cantilever; and
input/output conductive wires for passing a signal of one input conductive wire to one of two output conductive wires by making electrical contact with the contact metal plate according to seesawing movement of the cantilever.

3. A toggle type SPDT MEMS switch comprising:
a magnetic field generating means for generating a magnetic field within a given
a cantilever located in the space;
a driving conductive wire provided in the cantilever for generating an electromagnetic force to drive the cantilever by interaction between the driving conductive wire and the magnetic field when current flows through the driving conductive wire;
a torsion bar for supporting a middle portion of the cantilever such that the cantilever seesaws; a post for supporting the torsion bar;
a current application conductive wire for connecting the post with the driving conductive wire;
electrostatic force metal plates arranged at both lower portions of the driving conductive wire in a position opposite to the driving conductive wire for generating an electrostatic force between the electrostatic force metal plates and the driving conductive wire when a voltage is applied to the electrostatic force metal plates;
a contact metal plate provided in the bases of both ends of the cantilever; and
input/output conductive wires for passing a signal of one input conductive wire to one of two output conductive wires by making an electrical contact with the contact metal plate according to seesawing movement of the cantilever.

4. The toggle type SPDT MEMS switch as set forth in claim 2, wherein the cantilever is formed of an isolator.

5. The toggle type SPDT MEMS switch as set forth in claim 4, wherein the isolator comprises a silicon oxide or a silicon nitride.

6. The toggle type SPDT MEMS switch as set forth in claim 2, wherein all elements except the magnetic field generating means are integrated on a substrate.

7. The toggle type SPDT MEMS switch as set forth in claim 6, wherein the substrate comprises a silicon substrate or a glass substrate.

8. The toggle type SPDT MEMS switch as set forth in claim 3, wherein the cantilever is formed of an isolator.

9. The toggle type SPDT MEMS switch as set forth in claim 3, wherein all elements except the magnetic field generating means are integrated on a substrate.
